(19) United States
(12) Patent Application Publication
(10) Pub. No.: US 2013/0212664 A1
(43) Pub. Date: Aug. 15, 2013

(54) Player, Mobile Communication Device, Authentication Server, Authentication System and Method

(71) Applicants: Jun Luo, Huizhou City (CN); Qi Ge, Huizhou City (CN)

(72) Inventors: Jun Luo, Huizhou City (CN); Qi Ge, Huizhou City (CN)

(73) Assignee: HUIZHOU TCL MOBILE COMMUNICATION CO., LTD., Huizhou City, Guangdong Province (CN)

(21) Appl. No.: 13/877,159

(22) PCT Filed: Oct. 12, 2011
(86) PCT No.: PCT/CN2011/080714

§ 371 Date: Mar. 30, 2013

(30) Foreign Application Priority Data
Dec. 31, 2010 (CN) 201010619857.3

(51) Int. Cl. H04L 29/06

(52) U.S. Cl. CPC H04L 63/08
USPC 726/7

(57) ABSTRACT

Disclosed is an authentication method, including: acquiring authentication data recorded in an audio-visual product using a player and sending the authentication data to a mobile communication device; sending the authentication data to an authentication server using the mobile communication device; authenticating the authentication data using the authentication server to acquire the authentication result; and sending the authentication result to the player using the mobile communication device. Further provided are a player, a mobile communication device, an authentication server and an authentication system. By way of the above method, the technical solution provided in the present invention can provide reliable copyright protection for audio-visual products.

### TECHNICAL FIELD

The present invention relates to the technical field of communications, and more particularly to a player, a mobile communication device, an authentication server, an authentication system and method.

### BACKGROUND TECHNOLOGY

As piracy starts to cause serious impact to the survival and development of the audio-visual industry, various copyrighted-content-based encryption and authentication methods emerge. However, the conventional encryption and authentication techniques all attempt to prevent reproduction by way of encryption based on a disk carrier, and the authentication process is always conducted on the player side. Since the authentication information and services both happen on the player side, illegal users are very likely to successfully break into the player, such that the conventional technology fails to provide reliable copyright protection for the audio-visual products.

In view of the above, there exists an urgent need to provide a new authentication solution, wherein authentication information and authentication service are separated from each other. Unlike the existing anti-duplication technology, this new solution no longer incurs both the authentication information and the authentication process on the player side, thereby making it unlikely to break into a player and thus providing a more reliable copyright protection for the audio-visual products.

### SUMMARY OF THE INVENTION

The object of the present invention is to provide a player, a mobile communication device, an authentication server, an authentication system and method, which address the defect existing with the conventional technology that a player is likely to be broken into due to coexistence of the authentication information and the authentication process on the player side, and accordingly provides more reliable copyright protection for the audio-visual products.

To fulfill the aforesaid object, the present invention provides an authentication system, which comprises: a player, comprising: an authentication data acquisition module adapted to acquire authentication data from an audio-visual product; and a transceiving module adapted to transmit the authentication data; a mobile communication device, comprising: a first transceiving module adapted to receive the authentication data from the player; and a second wireless transceiving module adapted to transmit the authentication data; and an authentication server, comprising: a wireless transceiving module adapted to receive the authentication data; and an authentication module adapted to authenticate the authentication data to provide an authentication result, wherein the wireless transceiving module is further adapted to transmit the authentication result to the mobile communication device, which authentication result is received by the second wireless transceiving module of the mobile communication device and then forwarded by the first transceiving module of the mobile communication device to the transceiving module of the player.

The player further comprises a first data processing module adapted to integrate the authentication result into a first data packet of a first data format, the first data packet of the first data format comprising Segment “Frame Begin”, Segment “Add”, Segment “Type”, Segment “LEN”, Segment “Data”, Segment “CRC”, and Segment “Frame End”, wherein Segment “Data” includes the authentication data or a control command.

The mobile communication device further comprises a second data processing module adapted to integrate the authentication data into a TCP data packet.

To fulfill the aforesaid object, the present disclosure also provides an authentication method, comprising: a) acquiring authentication data recorded in an audio-visual product using a player, and transmitting the authentication data to a mobile communication device; b) transmitting the authentication data from the mobile communication device to an authentication server; c) authenticating the authentication data at the authentication server to provide an authentication result; and d) transmitting the authentication result from the mobile communication device to the player.

Step a) comprises integrating the authentication data into a first data packet of a first data format using the player, the first data packet of the first data format comprising Segment “Frame Begin”, Segment “Add”, Segment “Type”, Segment “LEN”, Segment “Data”, Segment “CRC”, and Segment “Frame End”.

Segment “Data” comprises the authentication data or a control command.

Step b) comprises integrating the authentication data into a TCP data packet by the mobile communication device.

To fulfill the aforesaid object, further disclosed in the present disclosure is a player for rendering an audio-visual product, comprising: an authentication data acquisition module adapted to acquire authentication data from an audio-visual product; and a transceiving module adapted to transmit the authentication data to a mobile communication device and receive an authentication result from the mobile communication device.

The player further comprises a first data processing module adapted to integrate the authentication data into a first data packet of a first data format, the first data packet of the first data format comprising Segment “Frame Begin”, Segment “Add”, Segment “Type”, Segment “LEN”, Segment “Data”, Segment “CRC”, and Segment “Frame End”, wherein Segment “Data” includes the authentication data or a control command.

The present invention also discloses a mobile communication device, comprising: a first transceiving module adapted to receive authentication data from a player; and a second wireless transceiving module adapted to transmit the authentication data to an authentication server and receive an authentication result from the authentication server, which authentication result is then transmitted from the first transceiving module to the player.

The mobile communication device further comprises a second data processing module adapted to integrate the authentication data into a TCP data packet.

Further provided in the present invention is an authentication server, which comprises a wireless transceiving module adapted to receive from a mobile communication device authentication data associated with an audio-visual product in a player; and an authentication module adapted to authenticate the authentication data to provide an authentication result, wherein the wireless transceiving module is further adapted to transmit the authentication result to the mobile communication device.

To fulfill the aforesaid object, the preset invention further discloses an authentication system, comprising: a player adapted to acquire authentication data recorded in an audio-visual product; a mobile communication device adapted to receive the authentication data from the player; and an authentication server adapted to authenticate the authentication data received from the mobile communication device to provide an authentication result, wherein the authentication server transmits the authentication result to the mobile communication device, which forwards the authentication result to the player.

Advantageously, unlike the conventional technology, the present invention authenticates an audio-visual product using an authentication server over a wireless network. Consequently, it would be impossible to render the audio-visual product even if it is illegally copied because the decryption and authentication remains undone. Therefore, the present invention can effectively prevent illegal duplication of an audio-visual product.

### BRIEF DESCRIPTION OF THE DRAWINGS

The technical solutions presented in the present disclosure will be more apparent from the following brief description of the drawings which will be referred to in the embodiments to be set forth below. Obviously, these drawings should be construed to be illustrative only, and starting from these given drawings, persons skilled in the art would be able to derive the other drawings without exercising any inventive skills.

FIG. 1 is a structural diagram of an authentication system in accordance with a first embodiment of the present disclosure;

FIG. 2 is a work flow diagram of the authentication system in accordance with the first embodiment of the present disclosure;

FIG. 3 illustrates data transmission associated with the authentication system in accordance with the first embodiment of the present disclosure;

FIG. 4 is a structural diagram of an authentication system in accordance with a second embodiment of the present disclosure; and

FIG. 5 illustrates a data frame format associated with the player and the mobile communication device included in the authentication system in accordance with the second embodiment of the present disclosure.

### DETAILED DESCRIPTION OF THE INVENTION

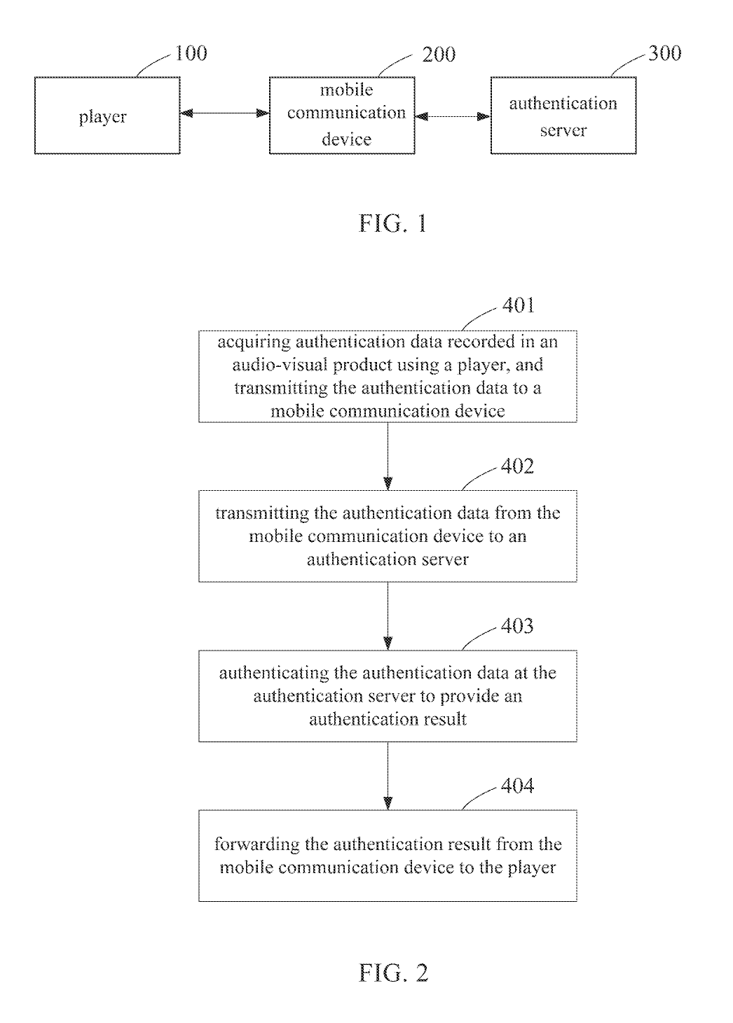

FIG. 1 is a structural diagram of an authentication system in accordance with a first embodiment of the present disclosure. The authentication system as shown in FIG. 1 comprises: a player 100, a mobile communication device 200 and an authentication server 300.

The player 100 is adapted to acquire authentication data recorded in an audio-visual product; the mobile communication device 200 is adapted to receive the authentication data from the player 100; and the authentication server 300 is adapted to authenticate the authentication data received from the mobile communication device 200 to provide an authentication result, and transmit the authentication result to the mobile communication device 200. The authentication result is then forwarded from the mobile communication device 200 to the player 100.

In a preferred embodiment, the player 100 may be used to play an audio-visual product such as a BD (Blue-ray Disc), DVD (Digital Versatile Disc) and CD (compact disc). The mobile communication device 200 may include terminals such as a mobile phone, a lap top computer, and a PDA (Personal Digital Assistant). The authentication server 300 may be implemented as a computer equipped with certain computing capability.

Now turning to FIG. 2, FIG. 2 illustrates a work flow diagram of the authentication system in accordance with the first embodiment of the present disclosure. As is shown therein, the authentication method in accordance with the first embodiment of the present disclosure comprises:
Step 401: acquiring authentication data recorded in an audio-visual product using a player 100, and transmitting the authentication data to a mobile communication device 200;
Step 402: transmitting the authentication data from the mobile communication device 200 to an authentication server 300;
Step 403: authenticating the authentication data at the authentication server 300 to provide an authentication result;
Step 404: forwarding the authentication result from the mobile communication device 200 to the player 100.

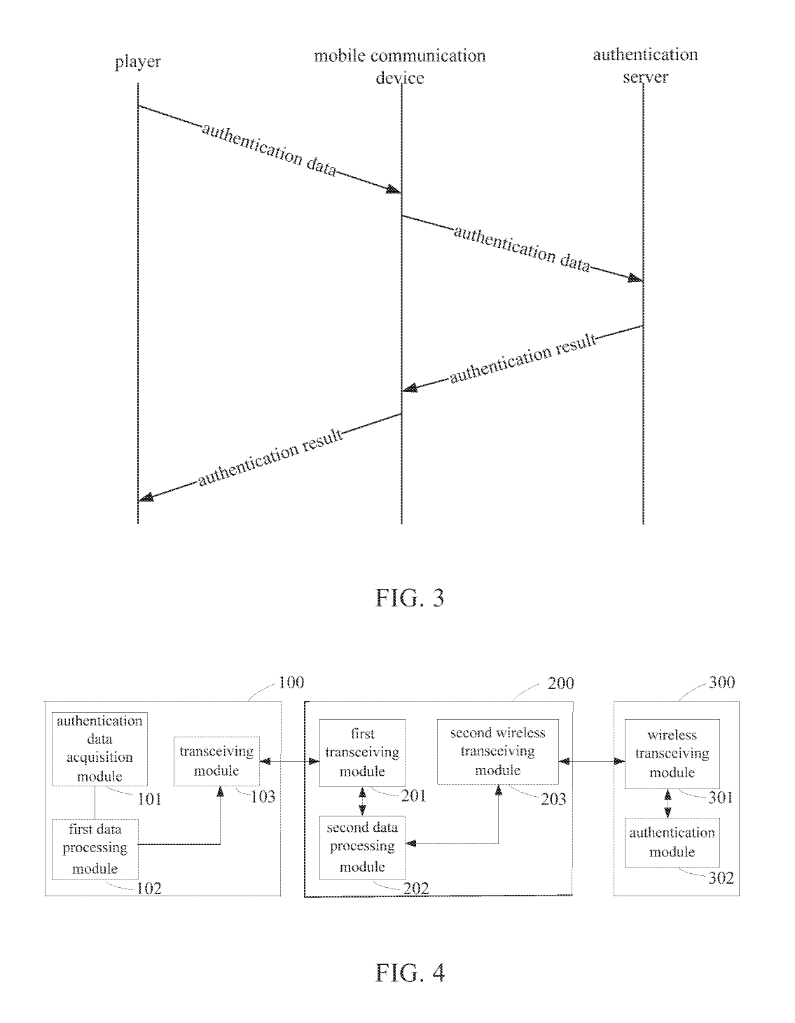

The method as provided will be illustrated more clearly with reference to FIG. 3, which illustrates data transmission associated with the authentication system in accordance with the first embodiment of the present disclosure. As is shown in FIG. 3, the mobile communication device 200 forwards the authentication information which the player 100 acquires from the audio-visual product to the authentication server 300. Based on the authentication information, the authentication server 300 generates the corresponding authentication result, and eventually returns the authentication result to the player 100 through the mobile communication device 200. The player 100 then determines whether to render the audio-visual product based on the authentication result. For example, if the authentication result indicates that it is authorized to render the audio-visual product, the player 100 may render the product. On the contrary, if the authentication result indicates that it is forbidden to render that product, the player 100 will refuse to render the product according to the authentication result.

Generally speaking, the authentication information may be implemented as an encrypted key. Based on the encrypted key, the authentication server 300 may compute the authentication result according to a pre-defined algorithm.

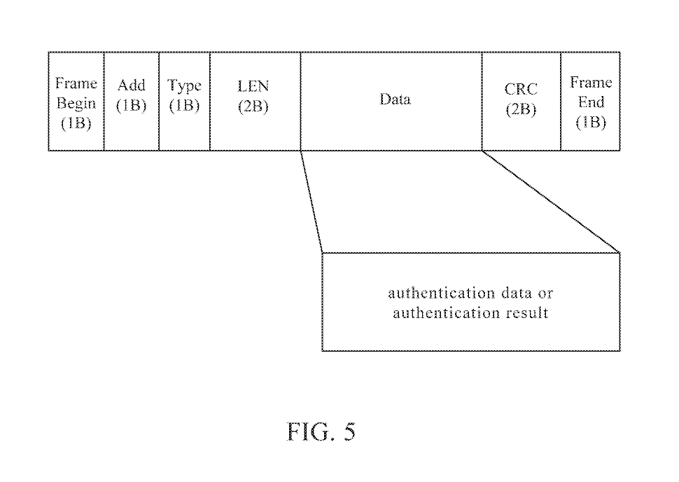

Reference is now made to FIG. 4, which illustrates an authentication system in accordance with a second embodiment of the present disclosure. This embodiment illustrates, in greater details, the modular structure of the player 100, the mobile communication device 200 and the authentication server 300 included in the authentication system in accordance with the first embodiment.

In the second embodiment of the present disclosure, the player 100 comprise: an authentication data acquisition module 101, a first data processing module 102, and a transceiving module 103, wherein the authentication data acquisition module 101 is adapted to acquire authentication data from an audio-visual product; the first data processing module 102 is adapted to integrate the authentication data into a first data packet of a first data format; and the transceiving module 103 is adapted to transmit the first data packet of the first data format to the mobile communication device 200. In addition, the transceiving module 103 of the player 100 is configured to receive an authentication result from the mobile communication device 200.

The mobile communication device 200 comprise: a first transceiving module 201, a second data processing module 202, and a second wireless transceiving module 203. The first transceiving module 201 is adapted to receive the authentication data from the transceiving module 103 and forward the authentication data to the second data processing module 202. In particular, the first transceiving module 201 receives the first data packet including the authentication data from the transceiving module 103 and transmits the first data packet to the second data processing module 202. Upon acquisition of the authentication data from the first transceiving module 201, the second data processing module 202 integrates the authentication data into a second data packet of a second data format, and transmits the second data packet to the second wireless transceiving module 203, which then sends the second data packet of the second data format, which includes the authentication data, to the authentication server 300.

In addition, the second wireless transceiving module 203 is configured to receive the authentication result having the second data format from the authentication server 300, and transmit it to the second data processing module 202. After the second data processing module 202 converts the authentication result to the first data format, the first transceiving module 201 transmits the authentication result to the transceiving module 103 of the player 100.

The authentication server 300 comprises a wireless transceiving module 301 and an authentication module 302, wherein the wireless transceiving module 301 is adapted to authenticate the authentication data associated with the audio-visual product of the player 100 received from the second transceiving module 203, and provide an authentication result, which is then transmitted from the wireless transceiving module 301 to the second transceiving module 203.

It is worth noting that after the acquisition of the authentication result based on the authentication data at the authentication server 300, the wireless transceiving module 301 transmits the authentication result in a second data format to the second wireless transceiving module 203 of the wireless communication device 200. The second wireless transceiving module 203 subsequently converts the authentication result in the second data format to the first data format. Afterwards, the first transceiving module 201 transmits the authentication result having the first data format to the transceiving module 103 of the player 100. So far, the player 100 is able to determine whether to render the audio-visual product according to the authentication result.

Hereunder reference is made to FIG. 5 to describe in greater details the data transmission between the player 100 and the mobile communication device 200. In particular, FIG. 5 illustrates a frame format of the data being communicated between the player 100 and the mobile communication device 200 included in the authentication system in accordance with the second embodiment of the present disclosure. The player 100 and the mobile communication device 200 may be connected with each other wiredly or wirelessly using, for example, a USB, a serial interface, Bluetooth or WIFI. That is, the first data packet having the first data format may be communicated between the player 100 and the mobile communication device 200 in the aforesaid manners.

The data format of the first data packet may be as shown in FIG. 5, which includes Segment “Frame Begin” (the beginning of a frame), Segment “Add” (Address), Segment “Type”, Segment “LEN” (length), Segment “Data”, Segment “CRC” (Cyclic Redundancy Check), and Segment “Frame End” (the end of a frame). The length of various segments may be defined as needed. For example, preferably, Segment “Frame Begin” has a length of one byte (1 B); Segment “Add” of one byte; Segment “Type” of one byte; Segment “LEN” of two bytes, Segment “Data” has a length ranging from zero to 127 bytes; Segment “CRC” of one byte; and Segment “Frame End” of one byte.

The data frame format as shown in FIG. 5 may be more fully understood with reference to Table 1.1 to be set forth below.

TABLE 1.1

| Frame | | | | Data | | Frame |
|---|---|---|---|---|---|---|
| Begin | Add | Type | LEN | (0~127 | CRC | End |
| (1 byte) | (1 byte) | (1 byte) | (2 bytes) | bytes) | (2 bytes) | (1 byte) |
| 0xF9 | reserved | 0x01 | *** | Data | CRC | 0xF9 |
| | | | | length | | |

As is illustrated in Table 1.1, Segment “Frame Begin” may be defined as 0×F9; Segment “Frame End” as 0×F9. Therefore, during the data transmission, when “0×F9” is detected for the first time, it is determined as Segment “Frame Begin”, and it starts to receive the frame data. When “0×F9” is detected for the second time, the end of the frame is determined. The data received between the two “0×F9” may be stored as a frame of data. Subsequently, the next “Frame Begin” is to be detected to receive the next frame of data.

Additionally, Segment “Add” may be set to “reserved” in order to distinguish data channels; Segment “Type” may define whether the information included in Segment “Data” belongs to data or a control command. Details may be seen in the following Table 1.2.

TABLE 1.2
Definitions of Segment “Type”

| | |
|---|---|
| 0x01 | Segment “Data” includes data content (0 to 127 bytes) |
| 0x02 | Segment “Data” include a control command (2 bytes) |

As Table 1.2 illustrates, when Segment “Type” is set to “0×01”, it means that Segment “Data” includes data content having a length between 0 and 127 bytes; while when Segment “Type” is set to “0×02”, it means that Segment “data” includes a control command having a length of two bytes.

The following Table 1.3 is to illustrate Segment “Data” in greater details.

TABLE 1.3
Definitions of Segment “Data”

| Type = 0x01 | data | | |
|---|---|---|---|
| Type = 0x02 | → | 0x01, 0x00 | inquiring whether the wireless |
| Data = 2 byte | | | communication device has been |
| | | | connected to a network |
| | ← | 0x01, 0x01 | connected |
| | ← | 0x01, 0x00 | unconnected |

As is shown in Table 1.3, when Segment “Type” is set to “0×01”, it means that Segment “Data” includes data content, i.e., the authentication data or the authentication result in the present invention. When Segment “Type” is set to “0×02”, it means that Segment “Data” includes a control command. When Segment “Data” is set to “0×01, 0×00”, it denotes an inquiry of whether the wireless communication device has been connected to a network. If Segment “Data” is set to “0×01, 0×01”, it means that the wireless communication device has been connected to a network. By contrast, if Segment “Data” is set to “0×01, 0×00”, it means that the wireless communication device has not yet been connected to a network. Consequently, upon receipt of the data having the first data format, it is possible to gain knowledge of whether the wireless communication device 200 is connected to a network by observing the setting of Segment “Data”. The “network” referred to the network consisting of the wireless communication device 200 and the authentication server 300.

Segment “LEN” represents the length of Segment “Data”, and Segment “CRC” is adapted to perform a Cyclic Redundancy Check on the data frame.

In view of the above, the first data format according to the present disclosure may be implemented as the data format as shown in FIG. 5. The authentication data or authentication result may be integrated into the data packet having such a first data format, thereby providing the authentication data or result having the first data format. It bears mentioning that when the authentication data is integrated into the data packet of the first data format, Segment “Type” may be set to “0×01”, such that the authentication data or result is incorporated into each frame.

In addition, the second data format involved in the second embodiment of the present invention may preferably take a TCP data format. Accordingly, the second data packet having the second data format may be a TCP data packet. By integrating the authentication data into the TCP data packet, the authentication data having a TCP data format may be provided so as to be wirelessly transmitted between the wireless communication device 200 and the authentication server 300. Furthermore, the authentication result that the authentication module 302 achieves based on the authentication data may also be transmitted in a TCP data format from the wireless transceiving module 301 to the second wireless transceiving module 203.

It is worthwhile to note that the first data format disclosed above is simply a preferred manner for transmitting data between the player 100 and the wireless communication device 200. It would be appreciated that the same technical effect may also be fulfilled using the other frame structure having the same function. Likewise, the second data format as the TCP data format is also one of the preferred solutions for transmitting data between the authentication server 300 and the wireless communication device 200. Any other data transmission formats having the same function may be also used to produce the same technical effects. They do not make any restrictions to the scope of the present invention.

In view of the above, the present invention performs an authentication on an audio-visual product using an authentication server over a wireless network. Since the authentication process is conducted on the authentication server, it would be impossible to render the audio-visual product on the player even if the product is duplicated because the authentication server has not conducted decryption and authentication. Consequently, the present invention effectively prevents illegal reproduction of audio-visual products.

It should be appreciated that the aforesaid embodiments are illustrative only rather than limiting the scope of the present invention. Any equivalent substitutions or variations to the structures or work flows as disclosed in the description and the drawings of the present disclosure, or any applications of them directly or indirectly to the other relevant technical fields should be also considered to fall into the scope of the present invention.

1-13. (canceled)

14. A player for rendering an audio-visual product, comprising:
an authentication data acquisition module adapted to acquire authentication data from an audio-visual product; and
a transceiving module adapted to transmit the authentication data to a mobile communication device and receive an authentication result from the mobile communication device.

15. The player according to claim 14, wherein the player further comprises a first data processing module adapted to integrate the authentication data into a first data packet of a first data format, the first data packet of the first data format comprising Segment “Frame Begin”, Segment “Add”, Segment “Type”, Segment “LEN”, Segment “Data”, Segment “CRC”, and Segment “Frame End”, wherein Segment “Data” includes the authentication data or a control command.

16. A mobile communication device, comprising:
a first transceiving module adapted to receive authentication data from a player; and
a second wireless transceiving module adapted to transmit the authentication data to an authentication server and receive an authentication result from the authentication server, which authentication result is then transmitted from the first transceiving module to the player.

17. The mobile communication device according to claim 16, further comprising a second data processing module adapted to integrate the authentication data into a TCP data packet.

18. An authentication server, comprising:
a wireless transceiving module adapted to receive from a mobile communication device authentication data associated with an audio-visual product in a player; and
an authentication module adapted to authenticate the authentication data to provide an authentication result;
wherein the wireless transceiving module is further adapted to transmit the authentication result to the mobile communication device.

19. An authentication system, comprising a player, a mobile communication device and the authentication server according to claim 18:
the player for rendering an audio-visual product, comprising:
an authentication data acquisition module adapted to acquire authentication data from an audio-visual product;
a transceiving module adapted to transmit the authentication data to the mobile communication device and receive an authentication result from the mobile communication device;
the mobile communication device, comprising:
a first transceiving module adapted to receive the authentication data from the player;
a second wireless transceiving module adapted to transmit the authentication data to the authentication server and receive an authentication result from the authentication server, which authentication result is then transmitted from the first transceiving module to the player;
wherein the authentication server authenticates the authentication data received from the mobile communication device to provide the authentication result; and
the authentication server transmits the authentication result to the mobile communication device, which forwards the authentication result to the player.

20. The authentication system according to claim 19, wherein the player further comprises a first data processing module adapted to integrate the authentication result into a first data packet of a first data format, the first data packet of the first data format comprising Segment “Frame Begin”, Segment “Add”, Segment “Type”, Segment “LEN”, Segment “Data”, Segment “CRC”, and Segment “Frame End”, wherein Segment “Data” includes the authentication data or a control command.

21. The authentication system according to claim 19, wherein the mobile communication device further comprises a second data processing module adapted to integrate the authentication data into a TCP data packet.

22. An authentication method, comprising:
a) acquiring authentication data recorded in an audio-visual product using a player, and transmitting the authentication data to a mobile communication device;
b) transmitting the authentication data from the mobile communication device to an authentication server;
c) authenticating the authentication data at the authentication server to provide an authentication result; and
d) transmitting the authentication result from the mobile communication device to the player.

23. The authentication method according to claim 22, wherein Step a) comprises integrating the authentication data into a first data packet of a first data format using the player, the first data packet of the first data format comprising Segment “Frame Begin”, Segment “Add”, Segment “Type”, Segment “LEN”, Segment “Data”, Segment “CRC”, and Segment “Frame End”.

24. The authentication method according to claim 23, wherein Segment “Data” comprises the authentication data or a control command.

25. The authentication method according to claim 24, wherein Step b) comprises integrating the authentication data into a TCP data packet by the mobile communication device.
